(19) United States
(12) Patent Application Publication
(10) Pub. No.: US 2012/0166265 A1
(43) Pub. Date: Jun. 28, 2012

(54) NETWORKED GAMING SYSTEM WITH STORED VALUE CARDS AND METHOD

(75) Inventors: Bruce Rowe, Las Vegas, NV (US); John Sommer, Reno, NV (US); Bryan Kelly, Pleasanton, CA (US); Julia Childs, Reno, NV (US)

(73) Assignee: Bally Gaming, Inc.

(21) Appl. No.: 13/402,729

(22) Filed: Feb. 22, 2012

Related U.S. Application Data
(63) Continuation of application No. 12/272,599, filed on Nov. 17, 2008.
Application No. 12/272,599 is a continuation-in-part of application No. 11/938,242, filed on Nov. 9, 2007.
(60) Provisional application No. 60/865,528, filed on Nov. 13, 2006.

(51) Int. Cl. G06Q 30/02; G06Q 20/34; G06Q 40/00

(52) U.S. Cl. 705/14.17; 705/39

(57) ABSTRACT

Disclosed are gaming machines, gaming systems and methods including stored value cards. Networked gaming systems are described which include one or more gaming machines with a stored value card acceptor, casino and/or slot management systems with a stored value server for authenticating stored value cards, verifying stored value, and updating value associated with the stored value cards, and a kiosk system for issuing, validating, and accounting for value associated with updateable stored value cards.

### CROSS REFERENCE TO RELATED APPLICATIONS

This application is a continuation of U.S. patent application Ser. No. 12/272,599 filed Nov. 17, 2008 which application is a continuation-in-part and claims priority from U.S. patent application Ser. No. 11/938,242 filed on Nov. 9, 2007, which claims priority of U.S. Provisional Patent Application 60/865,528, filed Nov. 13, 2006, which are hereby incorporated by reference in its entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to wagering games, gaming machines, networked gaming systems and methods and, more particularly, to wagering games, gaming machines, networked gaming systems and methods including stored value cards.

2. Description of the Related Art

In the prior art, various types of gaming machines have been developed with different features to captivate and maintain player interest. In general, a gaming machine allows a player to play a game in exchange for a wager. Depending on the outcome of the game, the player may be entitled to an award which is paid to the player by the gaming machine, normally in the form of currency or game credits.

While patrons may conventionally utilize currency, redeemable cash out tickets generated by the various gaming machine at the end of gaming sessions, and networked gaming system credits associated with a player's account, such as promotional credits, there remains a need for providing wagering patrons with devices, systems and methods providing and utilizing alternative bearer instruments.

### SUMMARY OF THE INVENTION

In accordance with one or more embodiments of the invention, a networked gaming system includes one or more gaming machines with a stored value card acceptor and a stored value server for authenticating stored value cards, verifying stored value, and updating value associated with the stored value cards.

In accordance with one or more embodiments of the invention, a kiosk is provided for accepting currency or other financial instrument and issuing stored value cards in accordance with the currency or other financial instrument, generating a record and transmitting information about the transaction including an identifier associated with each issued stored value card. In accordance with one or more embodiments, a kiosk is provided for accepting and verified stored value cards and redeeming the stored value by issuing currency, updating a bank credit or debit account, or other financial instrument

In accordance with one or more embodiments of the invention, a stored value card is provided that includes a stored value card issuable by a kiosk and useable at a gaming device wherein the stored value amount and identifier is downloadable to the gaming device, updateable by the gaming device at the close of a gaming session, and subsequently redeemable at a kiosk for the updated stored value.

Other features and advantages will become apparent from the following detailed description, taken in conjunction with the accompanying drawings, which illustrate by way of example, the features of the various embodiments.

### BRIEF DESCRIPTION OF THE DRAWINGS

FIGS. 1, 1-1, and 1-2 (hereinafter collectively referred to as FIG. 1) collectively illustrate an integrated gaming and stored value card system including distribution sub-system, redemption sub-system, and feedback analysis sub-system utilizing stored value cards in accordance with one or more embodiments.

FIGS. 2A-2B illustrate a conventional magnetic card which may be encoded as a stored value card and utilized by a gaming machine card reader in accordance with one or more embodiments.

FIG. 3 illustrates a stored value integrated gaming system with an example functional flow in accordance with one or more embodiments.

FIG. 4A-4B illustrate example Microsoft Windows-based graphical displays which may be generated by a control station connecting to the stored value server and database and/or business intelligence server and database, and, executing a stored value card administration program (“Power Card Client”) in accordance with one or more embodiments.

FIG. 5A-5B illustrates an example stored value card (“Power Card”) Service architecture and flow process in accordance with one or more embodiments.

FIG. 6A-6B illustrates an example stored value card (“Power Card”) request and response format and/or protocol in accordance with one or more embodiments.

### DETAILED DESCRIPTION OF THE EMBODIMENTS

Various embodiments are directed to a gaming machine, gaming networks and methods, wherein stored value cards are generated and utilized in the gaming environment. The embodiments are illustrated and described herein, by way of example only, and not by way of limitation.

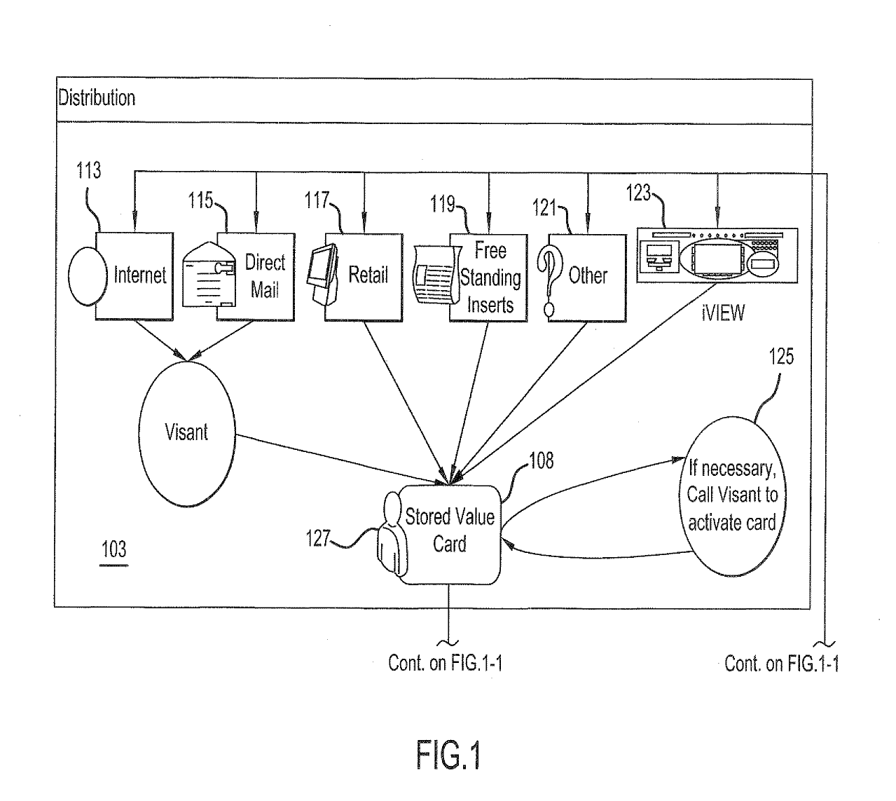

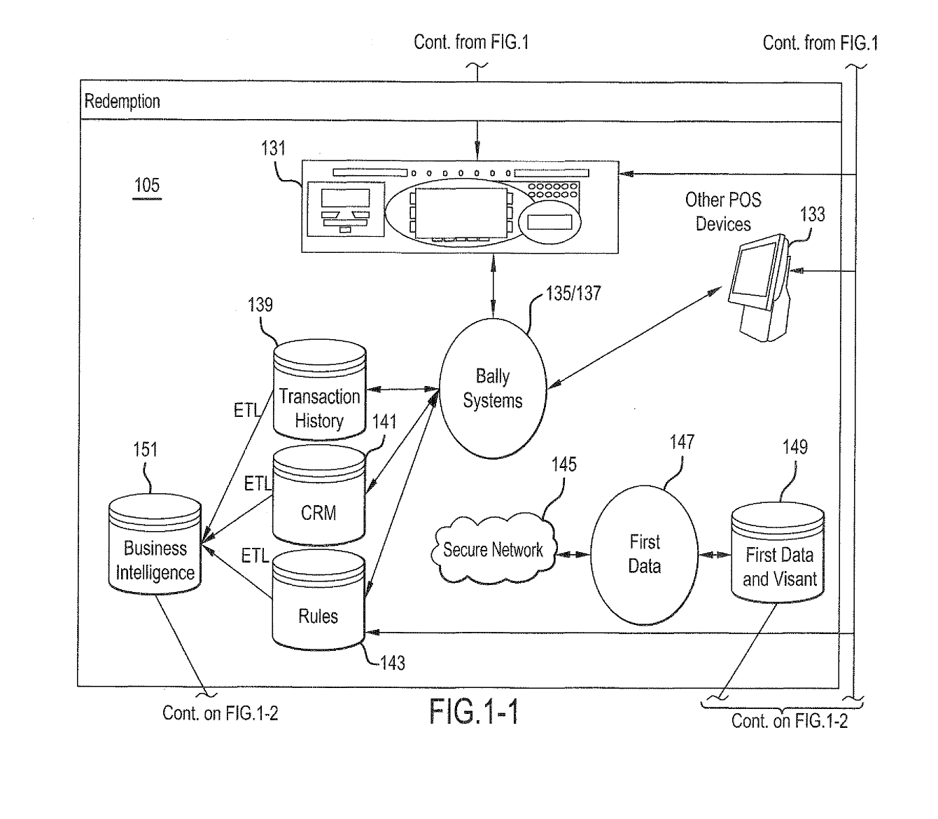

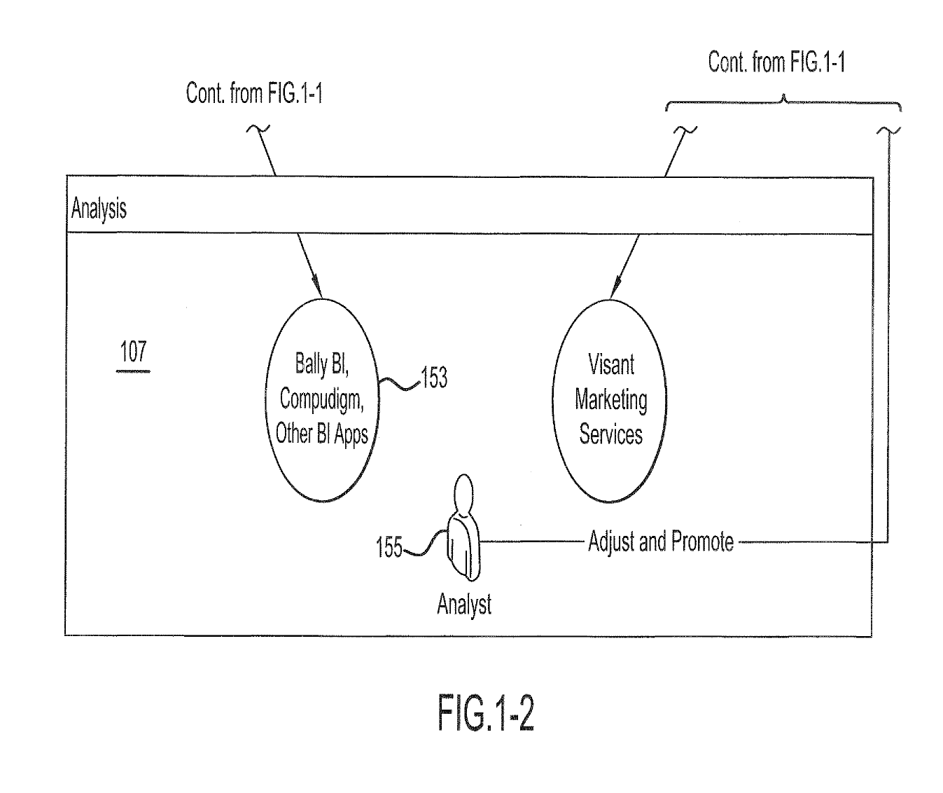

Referring to FIG. 1, integrated gaming and stored value card system 101 is shown including distribution sub-system 103, redemption sub-system 105, and feedback analysis sub-system 107 utilizing stored value cards 108.

Distribution sub-system 103 comprises a stored value card generator (not shown). The stored value card generator may include a card reader/writer which may embed selected information on conventional magnetic stripe cards to generate stored value cards 108 in accordance with programming executed by a processor board, such as a conventional motherboard. The embedded information may include a specific operator designation and a value, such as $20, which may be used by the operator's equipment to verify the stored value card is valid and determine the value. The stored value card generator may maintain a database containing the number of stored value cards 08 generated for the operator, the value of each stored value card and/or the total value, and/or a card identifier for each card, such that the stored value card generator and/or an associated stored value server 111 and database may be accessed to verify and/or validate each of the stored value cards when submitted for redemption. Stored value server 111 may comprise a conventional network connectable personal computer, server or workstation with executable programming to maintain a database of stored value cards 108 associated with an operator, to validate the stored value cards when presented for redemption, and to communicate with designated operator system components, such as by using a conventional G2S protocol approved by the GSA.

Each of the generated stored value cards 108 may be distributed by various mechanisms including:

Online Internet purchases—Operator's or an authorized vendor's site 113 connected to stored value server 111 may be included within integrated system 101 whereby customers may log on, request one or more stored value cards, enter payment information, such as a credit card, and designate a mailing address for delivery of stored value cards 08. Stored value cards 08 may then be mailed to the specified address.

Direct Mail promotions—Direct mail generator 115 connected to stored value server 111 may be included within integrated system 101 to distribute stored value cards 108 as part of one or more direct marketing campaigns.

Retail Outlets—Retail outlets 117 which may be owned by the operator, an authorized distributor, or a third party retailer, such as Walmart (miscellaneous merchandiser) or Albertson's (grocer), may be included within integrated system 101 whereby stored value cards 108 may be sold or provided promotionally. Retail outlets 117 may include network connected kiosks for transferring selected information to stored value server 111 or may implement accounting systems for transferring selected information to stored value server 111. In one or more embodiments, third parties, such as retailers, may enroll with an operator to accept player points from an operator's patrons to purchase retailer gift cards as well as operator stored value cards. In this embodiment, retailer and casino systems may connect to share player rewards data. Similarly, a retailer's loyalty program may have points that accumulate and that may be used to purchase an operator's stored value cards.

Free Standing Inserts—Printed publication and distributor 119 may include inserts with stored value card 108 and be included within integrated system 101.

Other—Alternative distributors 121 may be integrated within distribution sub-system 103 whereby stored value cards 108 may be distributed directly or bundled with other products and/or services. For example, stored value cards 108 may be distributed directly on the floor from casino employees; or, they may be left in rooms for guests when they check in. Stored value cards 08 may also be bundled with vacation or spa package deals.

iVIEW—User interface unit 121, such as a Bally iView, may be modified to include a stored valued card issuing device and be included within distribution sub-system 103 whereby customers may purchase stored value cards 108 from gaming machines using credits on the gaming machine, promotional value on a player's account, or by using some alternative currency medium, such as a credit or debit card.

In one or more embodiments, sub-system 103 may include activation server 125 whereby patron 127 may be required to telephone an activation phone number or access an activation website address connected to activation server 125 prior to redeeming a stored value card. Optionally, stored value cards 108 may not require separate activation and may simply be used by a patron at an authorized device or facility during a valid period.

Redemption sub-system 105 may include one or more player interface unit 131 with a stored value card reader for accepting one or more stored value cards 108. Player interface unit 108 may be integrated as a functional unit of an electronic gaming machine (EGM), such that the value associated with a validated stored value card may be downloaded to the credit meter for wagering on the EGM.

In one or more embodiments, redemption sub-system 105 may include alternative point-of-sale devices (POS) 133 which may be authorized by an operator to accept stored value cards 108 in exchange for purchases of products, such as food, beverages, clothes, gifts, etc., and/or services, such as spa and hotel services.

Redemption sub-system 105 further includes casino and slot management systems 135/137 network connected to each player interface unit 131 and alternative point-of-sale devices 133, and, providing a communication link to authenticate and validate each stored value card 108. Casino and slot management systems 135/137, such as a Bally SDS/CMS and SDS/SMS modified to accept stored value cards 108 and execute programming to perform the functions as described herein are referenced as CMS 135 and SMS 137, respectively, or CMS/SMS 135/137, collectively. CMS/SMS 1 35/1 37 may include a stored value server (not shown) and stored value transaction history, CRM, and rules databases 139, 141, 143. The stored value server may execute coding to communicate with each player interface unit 131 and POS device 133, enter and store a record of each stored value transactions in database 139, evaluate the stored value transaction in accordance with stored valued rules entered into a rules program stored in database 143. Example networked gaming systems as contemplated herein are more fully described in U.S. patent application Ser. No. 12/269712, filed 12 Nov. 2008, and is hereby incorporated by reference for all purposes.

The card redemption process includes two authorization steps. First the data is passed to a Bally systems where a rules engine will evaluate the transaction. If the transaction passes all the rules then the transaction is passed on to First Data for approval. For example, a promotional card could be created to offer $10 of free play on weekday morning before 11 AM. The rules program may be executed to evaluate the transaction including entering the date and time of the transaction, verifying stored value card 108 is a validly issued stored value card associated with the operator, determining that the stored value card has been presented for redemption during a valid period, and if so, determining the value associated with stored value card 108, and transmitting instructions to the EGM accordingly.

In one or more embodiments, redemptions sub-system may include secured network 145 connecting to third party stored value server 147 and associated stored value database 149 which may perform one or more of the authentication and validation rule steps described above. In which case, information concerning the authorization and settlement transactions associated with each stored value card 108 are recorded and maintained by one or more servers and respective databases, such as third party database 149 and transaction history database 139. In one or more embodiments, the third party may perform the functions associated with the generating and distribution of stored value cards in distribution sub-system 103, generate records associated with each stored value card which may include a unique identifier code and value, store the stored value card records in third party stored value database 149, and utilize the stored value card records to authenticate and validate each stored value cards when presenting for redemption. In the case where the operator stored value server performs these functions, then the stored value card records may be transmitted and maintained in a database by the stored value server associated with CMS/SMS 135/137 or accessible by the stored value server for authenticating and validating each stored value card 108.

CMS 137 may include a business intelligence (BI) server and database 151 including coding executable to evaluate gaming sessions associated with each stored value card 108. In the event that a patron, who has submitted stored value card 108 for redemption, is identified through a player card or other form of identification, such as biometric information, an existing player account may be accessed and information about the current gaming session entered.

Analysis sub-system 107 may include analysis control station 153 connectable with the BI server for used either in real-time or thereafter by analyst 155 to execute report summaries which may detail current activity of the patron and prior history and/or execute collective report summaries about gaming activity associated with redeemed stored value cards 108 during selected time frames. Using the information, analyst 155 may identify channels, such as retail outlets 117 or internet 113, utilized in distribution sub-system 103 that generated greater return-on-investment or more new customers than other channels, and, make adjustments such as increasing the number or retail outlets and/or marketing over the internet. In the event that a third party vendor is utilized to perform one or more of the functions associated with distribution sub-system 103, then third party analyst 155 may transmit instructions to third party server to effect the desired adjustments which may include the addition or deletion of various marketing promotions associated with the operator. Also, in the event that a third party vendor is being used, information associated with the stored value transactions may be accessed or transferred to BI database 151 for use by control station 153 as discussed herein. For example, stored value card issuance may be effected using conventional equipment and technology, such as is provided by Visant including its related services, and, accounting services may be provided conventionally by a financial institution or intermediary, such as by First Data, where the funds on deposit associated with the accounts may be insured by the FDIC.

In one or more embodiments, stored value server programming may also include modifiable redemption or use options enabling an authorized operator employee using a control station, such as a commercially available Bally control station, may execute a stored value server user program enabling the employee to display a set of display windows providing the status of various issued stored value cards, a listing of transactions, and various operator selectable and modifiable options of the stored valued card system. For example, a $50 face value stored value card may be used at any of the enabled operator facilities for wagers, services, and/or products until the value stored on the card is expended; however, an operator may modify the redemption value on the card if used at selected times, such as during mid-week when the operator may modify the redemption value to $60 of value or modify the redemption value to $70 of value if you are a casino patron with a player's card.

Thus, using the analytical tools and services implemented within CMS/SMS 135/137, casino operators may adjust their many stored value programs to increase their effectiveness. For example, analyst 155 may modify parameters or rules associated with one or more marketing programs and associated distribution channels, and, may modify programming to enhance the experience at the point of purchase, such as player interface unit 131 or alternative POS device 133 including PMS, Golf, Spa, etc.

In one or more embodiments, various promotions or rewards may be provided to patrons with player cards. For example, stored value cards 108 may be purchased through a hosted website and sent to a third party as a gift, such as a birthday, graduation, or anniversary gift. Patrons with player cards may obtain additional points or promotional benefits for purchasing stored value cards for either personal or third party use, or, if the stored value card is purchased by a patron with a player card and a third party recipient uses the stored value card as a first time patron of an operator then the patron who bought the stored value card may receive additional rewards for introducing the new patron.

In one or more embodiments, an example promotion may be implemented through periodicals with inserted stored value cards 108 (119) whereby the operator offers $10 of free play on stored value card 108 that may be included as a free standing insert (119) in Sunset Magazine for the region where the casino is located. To encourage the patron to redeem the stored value card during a period desired by the operator to increase business, the stored value card 108 may be valid for the next week or month or selected days or times during a given week or month. For example, if weekdays before 11 AM are typically not busy, the offer could provide an additional $10 if stored value card 108 is redeemed during that time frame.

In one or more embodiments, an example promotion may be initiated through direct mail generator 115 to encourage the return of prior patrons. For example, an operator may modify programming of the direct mail channel or initiate a new direct mail program that generates stored value cards 108 with a $50 value and sends them by mail to patrons who have been inactive for a period of time. Alternatively, a letter may be sent that may be brought to the casino and used to obtain stored value card 108 at an operator's patron services station. In one or more embodiments, CMS/SMS 135/137 may transmit a returning patron signal to an operator control station notifying an operator employee monitoring the control station of the event. Pursuant to the signal, the system may transmit a message to a patron services host including the patron name and location so that the patron services host may personally welcome the returning patron and provide any additional services or rewards that may be authorized by the operator.

In one or more embodiments, distribution sub-system 103 may include a marketing promotion through one or more channels, such as through player tracking unit 123 or direct mail generator 125 or regional retail outlets 117, whereby players may be offered discounted stored value cards valid for selected regions, such as Las Vegas, Atlantic City, Detroit, etc., where the operator seeks to drive its business. For example, a patron visiting Casino Las Vegas could be offered the opportunity through player interface unit 123 to purchase a $110 gift card for $100 that would be valid for the next six months at Casino Atlantic City which may be owned and/or operated by the same operator.

In an example embodiment, a stored value card (“Power Card”) integrated system may be comprised of the following sub-systems:

Power Card Server—Server host components include a Power Card Web Service and Power Card Windows Service.

Power Card Client—The Power Card Client application provides card activation, a report viewer, and general administration functions. Details are provided in the description of a stored value card client.

Reports—Reports may be created using SQL Server 2005 Reporting Services. Various reports may be available including: a Customer Disputes report which may provide the state and transaction detail for a specific account, Card Summary of transactions report which may provide a listing of all or a selected subset of redeemed or used stored value cards for a selected time frame, and, an Exceptions report which may provide a listing of errors encountered during processing of stored value cards for a selected time frame.

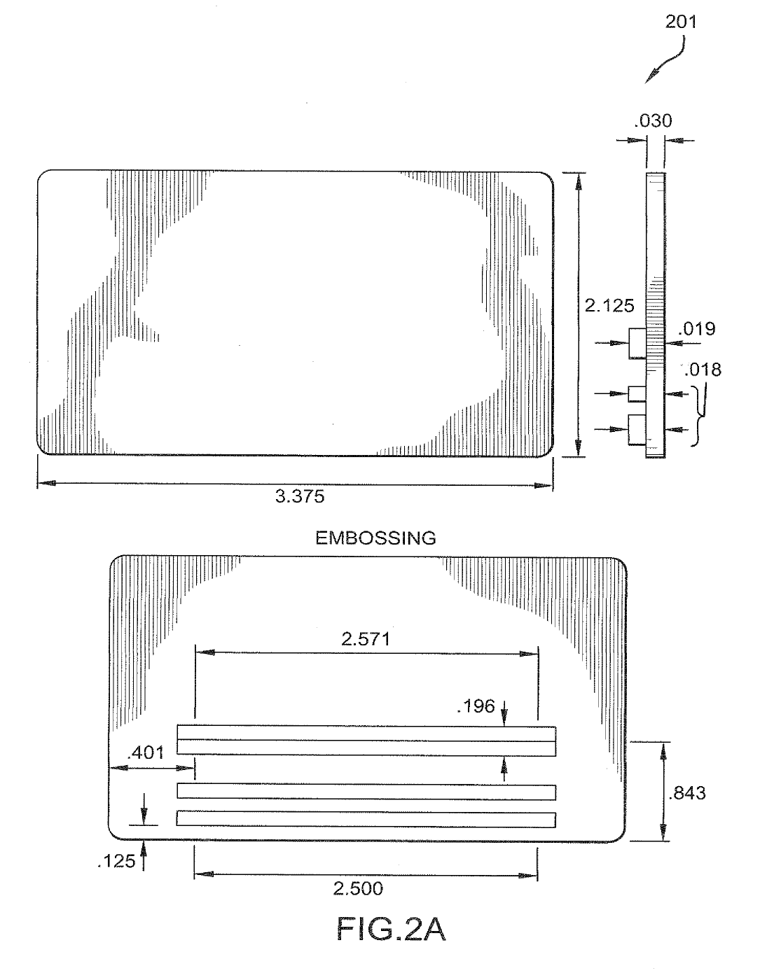

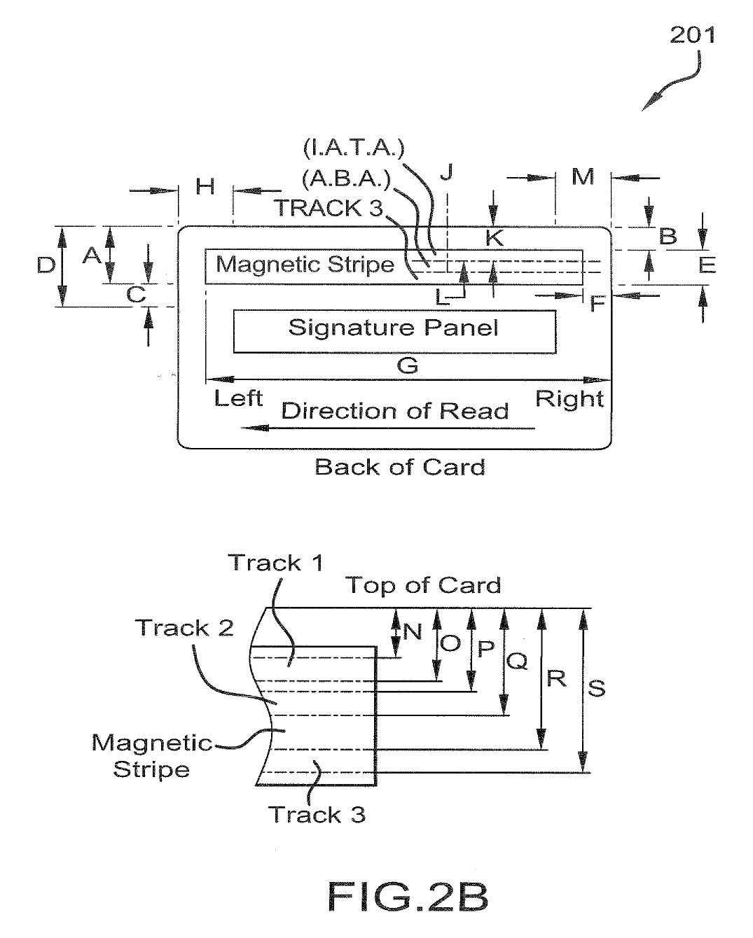

Referring to FIGS. 2A and 2B, conventional card 201 is shown in accordance with one or more embodiments which may be read by a card reader such as one included with player interface unit 123. Conventional card 201 may be comprised of a conventional magnetic stripe plastic or rigid paper card readable by a magnetic card reader, such as a card reader associated with player interface unit 123. Conventional card 201 may be generated to serve as a player card, stored value card, or other card, such as a credit or debit card.

For operation within a networked gaming system, the magnetic strip may be coded in a card format compatible for reading by EGM and/or CMS/SMS 135/137 and/or for translation into a format compatible with stored value server and/or other system devices required to implement the process. By example, some conventional magnetic stripe cards, such as player tracking and employee cards readable by conventional SDS networked gaming systems use Track 1 and Track 2. Stored value card 108 may be programmed using only one track and any additional information on a second track may be programmed to be ignored by player tracking unit 123. The stored value card application may be implemented using a limited amount of stored information which may include a Casino ID and an Account Number associated with the specific stored value card, such that stored value server may authenticate and validate a stored value card 108 submitted for redemption with data stored at or about the time of issuance of the stored value card and transmit or verify a value associated with the stored value card.

By example, an existing card protocol, such as a Bally SDS card reader protocol, may have three different formats on one track, such as Standard, Customer encoding, and/or Multi property encoding. All three formats for cards, such as player cards, read by player interface unit 123 may be on one track in descending order. Stored value cards 108 may only require and modify one of these formats, such as the multi-property format. Therefore, the same data may be duplicated three times on the card to make the card more robust against physical damage and clumsy card entries.

In one or more embodiments, stored value cards may have two modifications to the multi-property format. One may be the addition of a ‘Z’ value to the function type field to enable the system to identify the card as a stored value card as opposed to a player card. The other change may be to add additional characters to provide a 16 digit account code for a stored value card versus account codes that may be 10 digits for a player card.

Stored value cards may be conventionally formed with plastic or a rigid paper. Conventionally, the physical card may conform to the specifications of ISO7810 ID-1. Magnetic encoding may conform to ISO7811. Characters may be encoded in ANSI/ISO Alpha data format (7 bit, 6 data bits+1 parity bit (odd)) (enumerated in ISO7811). A Data field may be delimited by a start sentinel and ad end sentinel followed by an LRC (as defined in ISO7811)

An example stored value card multi-property encoding may conform to the following format: ‘cccZnnnnnnnnnnnnnnnn’, where: ccc=3 characters denoting the casino ID (the gmu will match this with its option table of acceptable casino id's; Z=the character ‘Z’ to distinguish a power card from a player card and an employee card; nnnnnnnnnnnnnnnn=16 numeric characters (0-9) designating the serial number of the card

An example of a fully delimited field may be: ‘% cccZnnnnnnnnnnnnnnnn?L’, %=start sentinel; ?=end sentinel; L=LRC (Longitudinal Redundancy Check). Given there may be room for a total of 79 characters on track one of a conventional ISO7811 magnetic stripe card, the encoded information may be repeated three times. Card readers associated with player interface unit 123 may operate together with a system game monitoring unit (GMU) housed with or connected to player interface unit 123 and the card reader, such that the card reader may be programmed to catch the first valid fully delimited field it finds and send the data portion to the GMU. If arbitrarily un-used character positions are filled with the ‘0’ character then an example of a full track on stored value card 108 may be: 0000% cccZnnnnnnnnnnnnnnnn?L000% cccZnnnnnnnnnnnnnnnn?L000% cccZnnnnnnnnnnnnnnnn?L

As discussed above, in one or more embodiments, a third party may perform one or more aspects of distribution sub-system 105. In such case, the protocols and formats utilized by CMS/SMS 135/137 may be translated into an associated protocol and format readable by a third party server. For example, the protocol used for communicating with a third party may comprise the third party's proprietary protocol. Information contained on stored value cards 108 may be translated to this protocol prior to sending to the third party server and the received responses may be translated into the protocol used by CMS/SMS 135/137.

In one or more embodiments, the stored value card does not store any individual patron's information and may be anonymously redeemed by any bearer. In one or more embodiments, the stored value card may be inserted into an EGM's card reader where it may be identified by the system and validated; once determined valid, the funds associated with the stored value card are downloaded onto the credit meter of the EGM where the funds may either be played or cashed out. In one or more embodiments, the patron may either insert a player card into a dual card reader or, in the case of a single card reader, remove the stored value card and insert the player card into the card reader, so that the patron may be identified by the system and associate the player's playing activity with his account for the accumulation of rewards points and eligibility for special bonuses, such as Bally's Power Winners. In one or more embodiments, with the player card inserted, the value on the credit meter may be uploaded to the player's account. In one or more embodiments where the patron may wish to play anonymously at another time, the amount remaining on the credit meter at the end of the session may be uploaded to the account associated with the stored value card. In one or more embodiments, the stored value card may be locked in the card reader during the entire playing session and when the patron concludes the session by pressing a cash out button, the amount on the credit meter may automatically be uploaded to the stored value card and the card reader then may release the stored value card for removal by the patron.

Example transactions which may be effected in the use of stored value cards at a gaming device using the networked gaming system including stored value card devices and processes, may include:

Stored Value Card (SVC) Transaction Type 1—Insert money into Casino Player Account

Player inserts SVC into player tracking card reader

Data read from SVC card and transferred to GMU

Card data is sent to casino server for authentication and validation

Card data forwarded to financial institution for available stored value balance

Stored value balance sent from financial institution to casino server

Casino server sends available Stored Value Balance to requesting EGM

Value presented to customer on iVIEW or on Main game screen

Customer inputs all or enters a specific amount of available Stored Value Balance

Player asked if he/she wants to store value into player account

If YES

Player removes Stored Value card

Player inserts Casino Players Club Card

Player enters PIN of Players Club Card into input device

If card and Pin are valid then authorization to put desired funds into Player account is approved

Stored Value Card financial institution notified by stored value server of CMS/SMS 135/137 of desired amount of withdrawal. If financial institution approves transaction then CMS 135 adds money to players account. Casino operator may optionally add bonus funds if card is used by a certain date or satisfies other business rules.

Financial institution reduces available Stored Value by approved amount.

Stored Value Card (SVC) Transaction Type 2—Transferred directly to Slot Machine for an Anonymous player.

Player inserts SVC into player tracking card reader

Player inserts SVC into player tracking card reader

Data read from SVC card

SVC Card data is sent to casino servers

Card data forwarded to financial institution for available stored value balance

Stored value Balance sent from financial institution to casino server

Casino server sends available Stored Value Balance to requesting EGM Value presented to customer on iVIEW or on Main game screen

Customer inputs all or enters a specific amount of available Stored Value Balance.

Player asked if he/she wants to store value into player account

If NO

Stored Value Card financial institution notified by CMS/SMS 135/137 of desired amount of withdrawal.

If financial institution approves transaction then Bally Systems add money to EGM specific temporary funds account at server. Casino may optionally add bonus funds if card is used by a certain date or other business rules.

Financial institution reduces available Stored Value by approved amount.

Temporary EGM specific funds account value transferred to EGM credit meter.

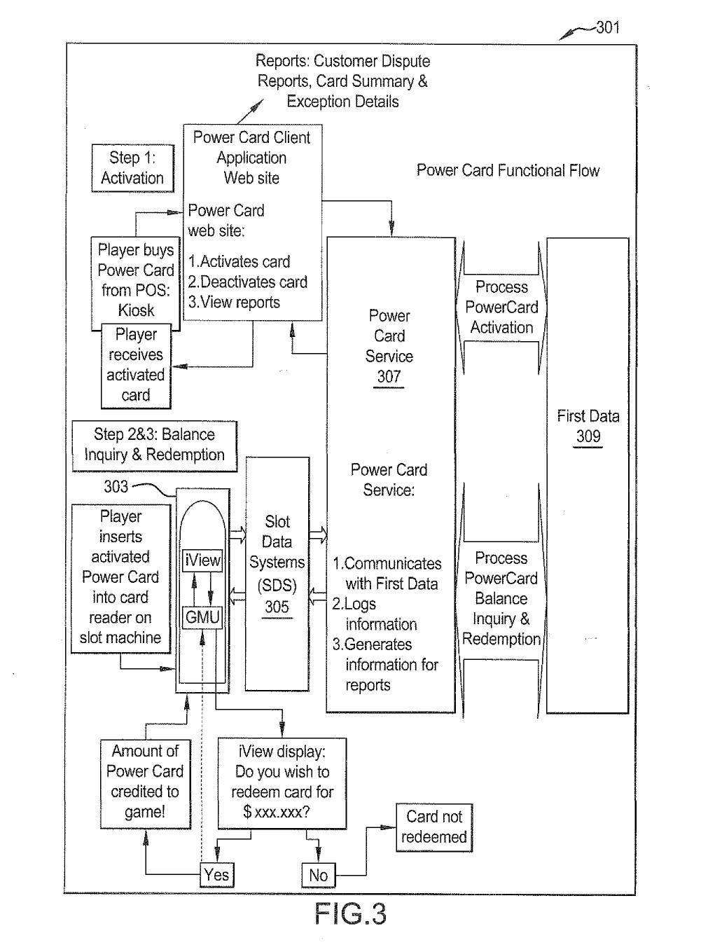

Referring to FIG. 3, stored value integrated gaming system 301 is shown with an example functional flow in accordance with one or more embodiments.

In an example stored value card (“Power Card”) purchase and redemption process the following steps may be implemented using a kiosk or as further described herein (not shown) for purchasing a stored value card, network-connected EGM 303 for receiving and redeeming the stored value card, slot data system 305 connecting to EGM 303 for facilitating communication and stored value transactions, Power Card Service 307, and Accounting (“First Data”) system 309. Once purchased, the card may be then activated by Casino personnel. The Power Card client application provides a function for card activation. Once the card is activated, the patron may insert the card in any EGM 303. A message may then be displayed on the player interface display, such as an iView display, for the value of the card and prompt the patron, “Do you wish to redeem $xx on the Game?” When the patron presses “Yes”, the corresponding funds are loaded on the game. Alternatively, the patron may ask for a selected amount to be redeemed from the card. If the patron presses “No”, the funds remain on the account and can be transferred at a later time.

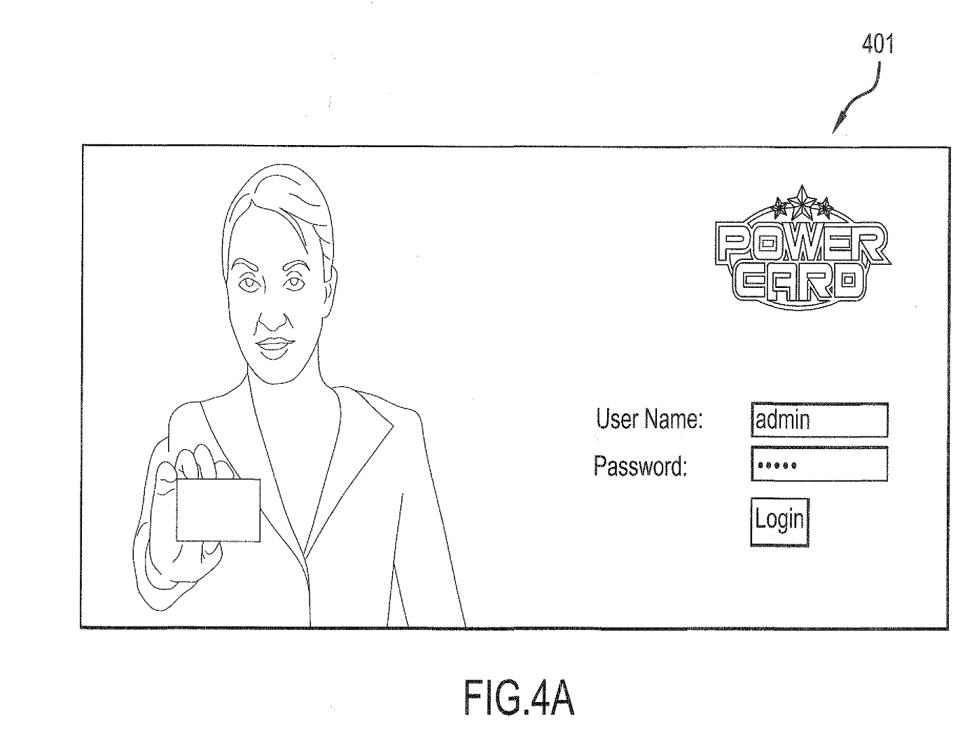

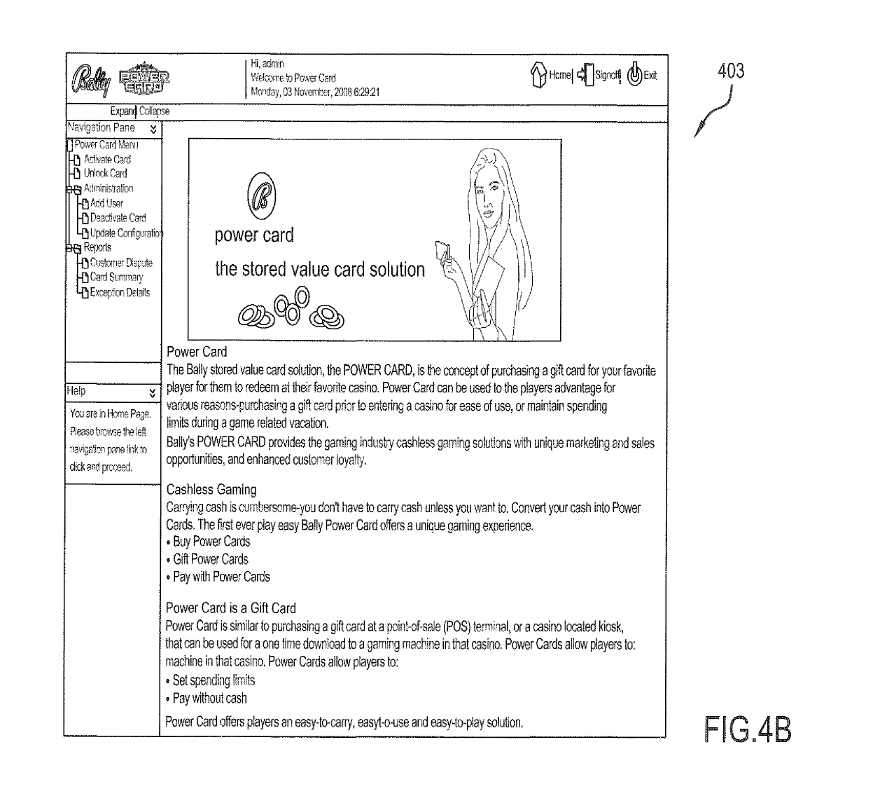

Referring to FIGS. 4A and 4B, example Microsoft Windows-based graphical displays 401 and 403 which may be generated by a control station connecting to the stored value server and database and/or business intelligence server and database, and, executing a stored value card administration program (“Power Card Client”) in accordance with one or more embodiments.

The Power Card Client may be a web-based GUI application and support one or more of the following functions:
Card Activation—Card Activation allows activating a single card or a range of cards.
Unlock Card—If the card is left in locked state and still holds the amount on the card, this option will allow the account to be unlocked. Once the card is redeemed this option cannot be used.
Administration—The following operations may be supported through the control station connecting to the stored value card server on CMS/SMS 135/137:
Add User—This would allow adding new accounts for casino personnel to use the client application.
De-activate Card—This functionality is provided for exception scenarios like the amount could not be redeemed on the card due to some technical issues, so the amount is issued to the user manually. In such case, the card may be deactivated to prevent duplicative usage.
Update Configuration—This interface may allow the client to configure information like merchant ID, alternate merchant ID, IP and Port of First Data connection, etc.
Customer Dispute Report—This report shows the audit trail pertaining to a single Card. This allows casino personnel to refer to this report in case of any conflict between what the patron think his/her card has vs. what the system says.
Card Summary Report—This report displays the transactions that happened during the time specified in terms of activations, balance inquiries and redemptions.

Exception Details Report—This report stores all the errors/validation failures that occurred during the specified date range.

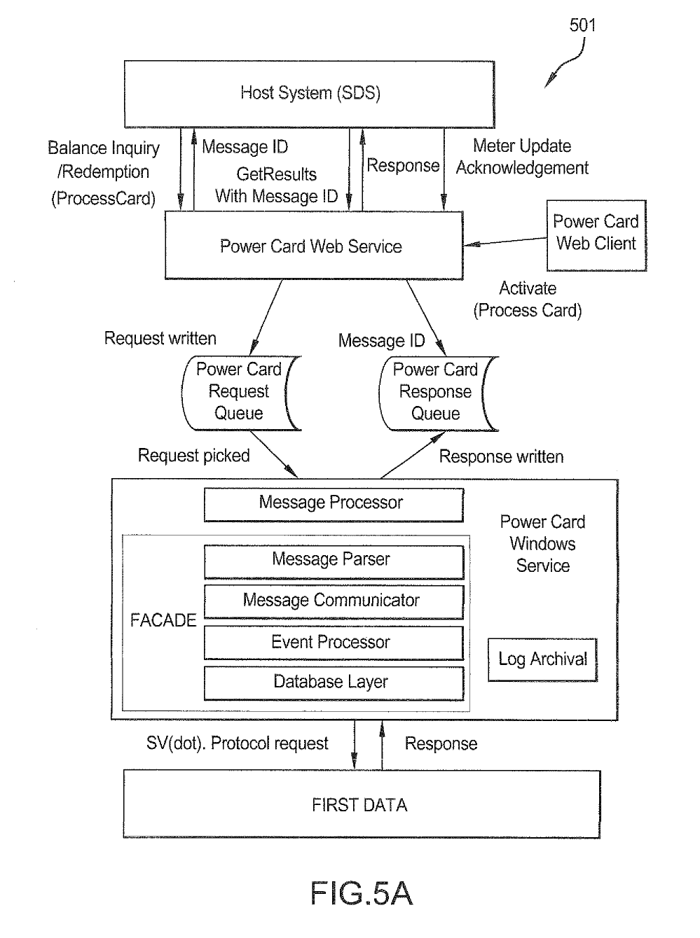

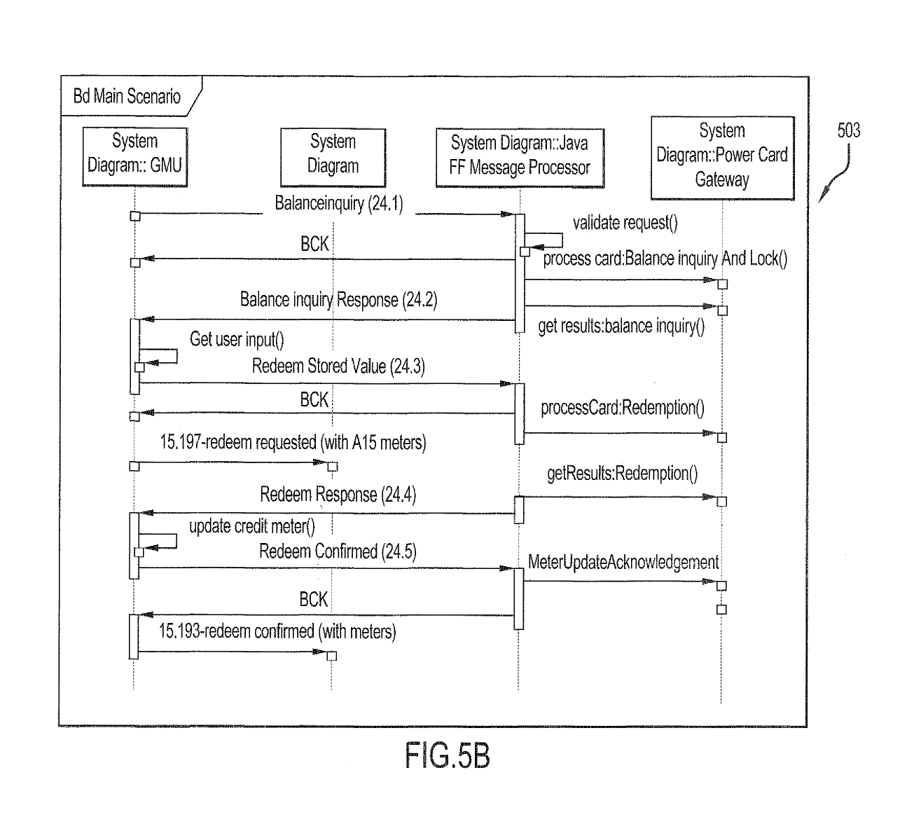

Referring to FIGS. 5A and 5B, example Power Card Service architecture 501 and flow process 503 are shown in accordance with one or more embodiments. One or more embodiments may include the following components:

Power Card Web Service—The Power Card web services may be SOAP based, such as SOAP binding 1.1. The Web Service may be written using Windows Communication Foundation (WCF) and may be hosted in an IIS.

ProcessCard—ProcessCard program may be executable by GMU when a patron initiated event occurs, such as a request to activate an account, perform a balance inquiry or redeem funds from the account. When the request is received, the GMU transmits a request to the stored value server on CMS/SMS 135/137 in accordance with the patron request and includes identifying information of the stored value card and EGM. Responsive to the request, the stored value server executes a response program which may include accessing the stored value card account information, authenticating the card, validating the value associated with the account, and transmitting a corresponding message to the EGM responsive to the request. In one or more embodiments, the stored value server or a server designated within the SDS, validates the request and writes the request to the Power Card Request Queue and returns the message ID generated (GUID) to the client.

GetResults—The client then may execute a GetResults program to get the result of the request submitted. This may be performed in a two step process. On the successful receipt of the Power Card Response through execution of the GetResults program, the host system (in the case of a redemption request) transfers the amount to the game.

MeterUpdateAcknowledgement—As part of an account redemption, this service may be called to acknowledge that funds have been transferred to the game and complete the card transaction. The condition (state) of the card may then be revised to a ‘confirmed’ condition.

Flow diagram 503 illustrates an example flow between the game, GMU, SDS, and Power card application:

Message Layer: Microsoft Message Queuing Service (MSMQ) may be leveraged to provide the messaging back bone. It may provide reliable messaging functionality, fault tolerance, and allow decoupling of the request and message processing.

Power Card Windows Service: The Power Card Windows service may continuously monitor the Power Card Request queue for new messages (for activation, balance inquiry or redemption). When a new message is written to the queue, the system may process the request using the components below and write the response to the Power Card Response Queue. The message may stay in the response queue until the host system (e.g. SDS) retrieves the response. It may perform this operation by invoking the GetResults service method and passing the message ID that was returned from the ProcessCard service.

Power Card Windows Service may include:

Message Processor: The Message Processor may manage MSMQ handling operations. It may be notified (message received event) of a message available in the Power Card Request queue. It may asynchronously submit the request to the Power Card Facade for processing and continue waiting for new messages. Additionally, it may also write the response received from the Event Processor component to the Power Card Response Queue.

Facade Layer: As the name suggests, this layer may use the Facade design pattern and manage the orchestration for other components to process the request. It may validate the request and invoke the Message Communicator.

Message Parser: The Message Parser may encapsulate the First Data message parsing logic, convert the request into a third party (First Data) protocol specific string. Additionally, it may convert the response stream received from the third party (First Data) into a generic object. Other SDS components may act on this generic object to perform various functions including updating the transaction database and transmitting a response to the requesting EGM.

Message Communicator: The role of the Message Communicator may be to connect with a third party (such as First Data), send requests, and receive responses. It is also may be responsible for maintaining continuous connectivity with First Data by sending keep-alive messages. This class may be a singleton in nature that allows maintaining a socket connection rather than getting a new socket connection for each message. This may help improve application performance. Calls to First Data may be made asynchronously to avoid blocking a calling thread. When the response is received from First Data, an event may be signalled to the Event Processor component that processes the event further. In the event a response is not received from First Data in the configured time-frame, the message communicator raises the event that a timeout condition occurred allowing the event processor to produce a response for the client that initiated the request.

Event Processor: As mentioned above, the Event Processor may handle the response received from First Data. It may use the Message Processor to parse the response stream received from First Data into a generic object and updates the database. It may then raises the event to process to the Message Processor to write the response into the Power Card Response Queue.

Database Layer: The Object Role Modeling (ORM) tool named NHibernate may be used to handle database operations. NHibernate is one of the popular open source ORM tools available and provides abstraction from the database design. This further encapsulates other database operations like transaction handling, state management, and caching to name a few.

Log Archival: Information may be logged at multiple levels in the log files. This component may operate on a separate thread and move older log files to a separate folder. The time duration for moving/cleaning the log files may be configured in the configuration file.

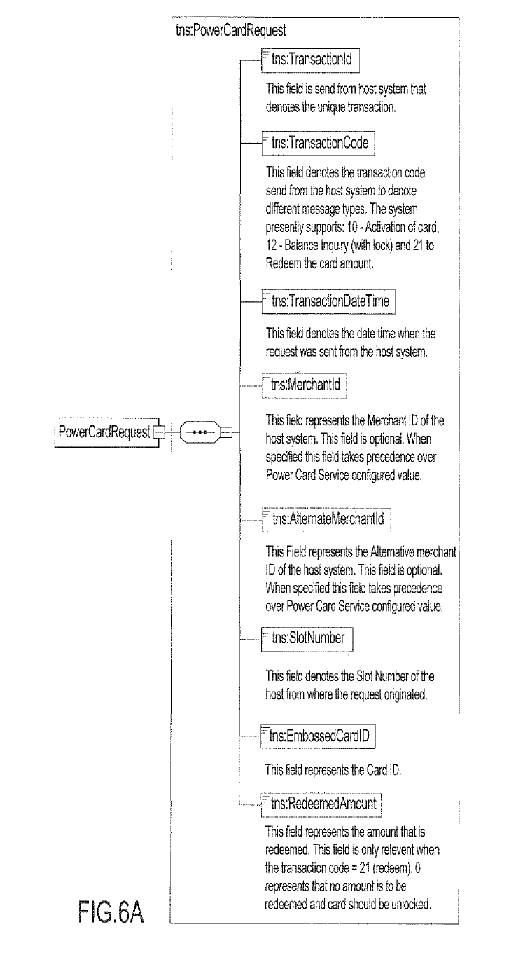

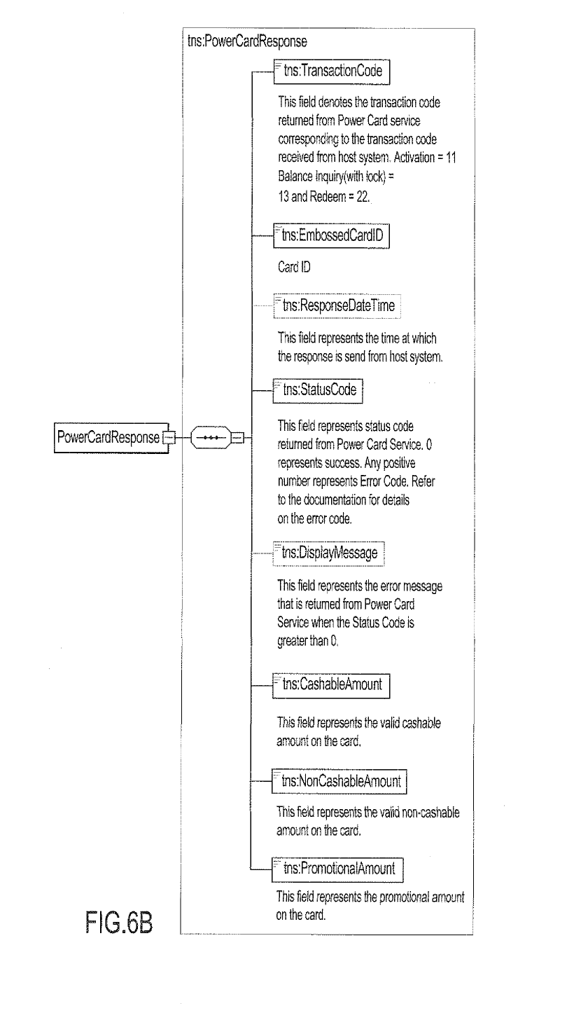

Referring to FIGS. 6A and 6B, an example stored value card (“Power Card”) request and response format and/or protocol is shown in accordance with one or more embodiments.

In the example, a third party stored value card vendor maintains a database of the information concerning each issued stored value card and its associated account as previously described in FIG. 1. Communication may be enabled through a conventional Web Service channel.

In the example, a stored value card may be inserted into a card reader of an EGM connected to CMS/SMS 135/137. Several options may be provided on the player interface display, such as Activate Card, Balance Inquiry, and Redemption requests, and the patron may select one of the options by pressing an associated button or the display (touch sensitive display). Accordingly, using its card reader executable programming, the GMU may use the information provided by the card and the associated request by the patron to generate the PowerCardRequest in format shown in FIG. 3A. The PowerCardRequest may be transmitted to the stored value server of CMS/SMS 135/137; whereupon, the stored value server may execute programming to create a transaction record in its transaction database and process the request in accordance with the rules implemented in its programming which in this example includes formatting the request in the format and protocol readable by the third party stored value card server and transmitting the reformatted Power CardRequest to the third party stored value card server. The translation step may be eliminated in one or more embodiments by incorporating a platform, such as WCF (Windows Communication Foundation). In which case, the Web Service may be created within WCF and provide a communication platform that allows the web service implementation to be separate from protocols and binding. This feature may allow moving to different protocols, binding and channels without changing the implementation.

One or more embodiments may provide a Message Parser. The parsing of the messages to and from a third party may be stored at a separate component. This allows loose coupling of the rest of the logic from the third party data protocol. At any later point of time if the third party changes its protocol, or CMS/SMS 135/137 needs to support new messages of reload, partial redemption, changes in the existing logic may not be required. This same module can be used to support different protocols since the definition is described in an XML format.

One or more embodiments may provide for the generating of a Customer Dispute Report through the control station. This report may allow viewing the state and entire transaction history for the card. In the case of disputes, this report will be used to see the audit trail associated with the card and provide for immediate response to the customer.

The various embodiments described above are provided by way of illustration only and should not be construed to limit the claimed invention. For example, it may further be appreciated that a stored value card in accordance with one or more aspects of the invention may be associated with a table game such as poker or blackjack.

Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A system for analyzing the use of stored value cards in an environment including (i) one or more gaming venues providing gaming at one or more gaming machines, (ii) point of sale (POS) venues offering goods or services for purchase and (iii) a communication network for said gaming and POS venues, said system comprising;
devices at said gaming machines and POS venues to read and redeem a value from a stored value card to engage in one more of a gaming or POS transaction;
a stored value card server in communication with said devices, said stored value card server storing data corresponding to each stored value card, the value stored thereon and redemption of all or a portion of said value;
a business intelligence (BI) server in communication with one or more of said devices and said stored value server to receive data corresponding to stored value card redemption activity configured to analyze said stored value card redemption activity.

2. The system of claim 1 where at least one gaming venue has apparatus at each gaming machine to identify a player and a player loyalty server storing data related to an indentified player's gaming activities, the system comprising one of said stored value server and BI server in communication with said loyalty server and configured to associate each indentified player with a stored value card redemption event.

3. The system of claim 2 where at said at least one gaming venue said players are issued loyalty cards to associate each player with a account at the player loyalty server to uniquely identify each player, said system comprising at least one card reader provided at each gaming machine configured to read said loyalty card and said stored value cards.

4. The system of claim 3 comprising said card reader is configured to read both said of said loyalty and stored value cards.

5. A method for analyzing the use of stored value cards in an environment including (i) one or more gaming venues providing gaming at one or more gaming machines, (ii) point of sale (POS) venues offering goods or services for purchase and (iii) a communication network for said gaming and POS venues, said method comprising;
at said gaming machines and POS venues reading and redeeming a value from a stored value card to activate a corresponding gaming or POS transaction;
communicating a stored value card use activity at said venues through said network to a stored value card server storing data corresponding to each stored value card, the value stored thereon and redemption events;
analyzing data from one or more of said stored value card server and said gaming machines and POS venues to generate reports reflective of said stored value card redemption activity.

6. A method for issuing and redeeming stored value cards in an environment including a plurality of gaming machines at one or more gaming venues and point of sale (POS) venues offering goods or services for purchase, said method comprising:
providing stored value cards to patrons for value or as a free promotion, each value card having associated therewith a value amount;
locating stored value card readers in association with said gaming machines and POS venues configured to access the value associated with a presented value card; and
configuring a server to communicate over a communication network with said stored value card readers, to verify the validity of a stored value card read at a reader and to, where a value is redeemed from a card, record said redemption event, location and amount.

7. The method of claim 6 comprising configuring an Internet website for the purchase of said stored value cards and arranging said server to record the purchase and value amount.

8. The method of claim 6 comprising providing a kiosk for purchasing value to be added to a value cards and configured said server to communicate with said kiosk over said communication network to record the value added to value cards.

9. The method of claim 6 comprising analyzing said server data to provide business intelligence including value card usage for said venues.
